(19) United States
(12) Patent Application Publication
(10) Pub. No.: US 2026/0286924 A1
(43) Pub. Date: Sep. 24, 2026

(54) FUEL INJECTOR OF AN INTERNAL COMBUSTION ENGINE AND INTERNAL COMBUSTION ENGINE

(71) Applicant: Everllence SE, Augsburg (DE)

(72) Inventors: Armin WEBER, Kammlach (DE); Maximilian INDRICH, Bobingen (DE); Dusan MIKESKA, München (DE)

(21) Appl. No.: 19/562,237

(22) Filed: Mar. 10, 2026

(30) Foreign Application Priority Data
Mar. 20, 2025 (DE) 10 2025 110 781.5

(51) Int. Cl. F02M 61/12; F02M 55/00

(52) U.S. Cl. CPC F02M 61/12; F02M 55/008

(57) ABSTRACT

A fuel injector for supplying fuel to a cylinder of an internal combustion engine, having a first nozzle needle moveably guided in a first needle guide, which interacts with first fuel injection orifices such that the first nozzle needle, depending on its position, either opens or blocks a fuel flow of a first fuel through the first fuel injection orifices, a second nozzle needle moveably guided in a second needle guide, which interacts with second fuel injection orifices such that the second nozzle needle, depending on its position, either opens or blocks a fuel flow of a second fuel through the second fuel injection orifices, a fuel storage space and a piston moveably guided in the fuel storage space. The piston, depending on its position in the fuel storage space, divides the fuel storage space into a first fuel storage subspace a second fuel storage subspace .

### BACKGROUND OF THE INVENTION

### 1. Field of the Invention

The disclosure relates to a fuel injector of an internal combustion engine. Further, the disclosure relates to an internal combustion engine having at least one fuel injector.

The disclosure present here relates in particular to the field of so-called large engines or large internal combustion engines, the cylinders of which have piston diameters of at least 140 mm, in particular of at least 175 mm. Such large internal combustion engines are, for example, ships' engines.

### 2. Description of Related Art

Dual fuel internal combustion engines are already known as ships' engines. Dual fuel internal combustion engines known from practice can be operated in a first operating mode in which the same combust a first fuel, in particular, a relatively ignitable fuel, and in a second operating mode, in which the same combust a second fuel, in particular, a relatively less ignitable fuel.

The first, relatively ignitable fuel can be, for example, a diesel fuel. The second, relatively less ignitable fuel can be, for example, methanol, ethanol, or ammonia.

In the second operating mode, the second, relatively less ignitable fuel, in particular, the methanol, ethanol, or ammonia, can be ignited via the first, relatively ignitable fuel, in particular, the diesel fuel. In the second operating mode, the first, relatively ignitable fuel serves as pilot fuel. A pilot fuel can also be referred to as ignition fuel.

DE10 2013000048 B3 discloses a fuel injector with the help of which both a first, relatively ignitable fuel and also a second, relatively less ignitable fuel can be introduced into a combustion chamber of a cylinder.

A first nozzle needle of the fuel injector can be supplied with the first fuel emanating from a first fuel reservoir, wherein a second nozzle needle of the fuel injector can be supplied with the second fuel emanating from a second fuel reservoir. In particular, when, as is usual in fuel injectors known from the prior art, the first fuel reservoir and the second fuel reservoir are provided by separate fuel reservoir spaces, the fuel storage volume that can be provided by the same when the separate fuel reservoir spaces are integrated in the fuel injector is restricted as a consequence of the limited space. It is therefore difficult with fuel injectors having fuel reservoirs integrated in the fuel injector to provide an adequate fuel storage volume for the respective fuel.

### SUMMARY OF THE INVENTION

Starting out from this, an object of one aspect of the present invention is based on creating a new type of fuel injector of an internal combustion engine, with the help of which in the first and second operating mode an adequate fuel volume for injection can be provided in each case. This object is achieved through a fuel injector and an internal combustion engine.

The fuel injector according to one aspect of the invention comprises a first nozzle needle moveably guided in a first needle guide, which interacts with first fuel injection orifices in such a manner that the first nozzle needle, depending on its position, either opens or blocks a fuel flow of the first fuel through the first fuel injection orifices.

Further, the fuel injector according to one aspect of the invention comprises a second nozzle needle moveably guided in a second needle guide, which interacts with second fuel injection orifices in such a manner that the second nozzle needle, depending on its position, either opens or blocks a fuel flow of a second fuel through the second fuel injection orifices.

Further, the fuel injector according to one aspect of the invention comprises a fuel storage space and a piston moveably guided in the fuel storage space, wherein the piston, depending on its position in the fuel storage space, divides the fuel storage space into a first fuel storage subspace for the first fuel and into a second fuel storage subspace for the second fuel.

In the fuel injector according to one aspect of the invention, the fuel storage space, which basically serves both for storing the first fuel and the second fuel, depending on the position of the piston moveably guided in the fuel storage space, can be flexibly divided into fuel storage subspaces with fuel storage volumes for the first fuel and the second fuel adapted to the respective operating mode. Depending on the operating mode of the internal combustion engine, a storage volume for the first fuel and the second fuel adapted to the operating mode can thus be provided for an optimal injection in the respective operating mode. Thus, it is possible to operate an internal combustion engine with such fuel injectors with lower emissions and higher efficiency.

Preferentially, the fuel injector for the piston comprises a first stop, against which the piston lies in the first operating mode of the internal combustion engine, further a second stop, against which the piston lies in the second operating mode of the internal combustion engine. This is preferred for adapting the fuel storage volumes of the first fuel storage subspace and second fuel storage subspace.

In particular, when the piston in the first operating mode of the internal combustion engine, in which the same exclusively combusts the first fuel, lies against the first stop, a volume of the first fuel storage subspace is maximal in such a manner that the volume of the first fuel storage subspace takes up the entire volume of the fuel storage space or almost the entire volume of the fuel storage space. In particular, when the piston in the second operating mode of the internal combustion engine, in which the same combusts the second fuel using the first fuel as pilot fuel, lies against the second stop, the first fuel storage subspace takes up a first part volume of the total volume of the fuel storage space and the second fuel storage subspace a second part volume of the total volume of the fuel storage space, wherein the second part volume is greater than the first part volume. For both operating modes of the internal combustion engine, an optimal fuel storage volume for the first fuel and the second fuel can be provided.

Preferentially, the piston, on a first side, has a first effective piston area and on a second side a second effective piston area, which are dimensioned in such a manner that in the first operating mode of the internal combustion engine, the piston, depending on fuel pressures effective on its piston areas, lies against the first stop and in the second operating mode of the internal combustion engine, the piston, depending on fuel pressures effective on its piston areas, lies against the second stop. In particular, when in the second operating mode of the internal combustion engine the piston lies against the second stop, the fuel pressure of the first fuel is applied to the first piston area effective in the region of the first fuel storage subspace and the fuel pressure of the second fuel is applied to the second piston area effective in the region of the second fuel storage subspace, wherein the effective second piston area is greater than the effective first piston area. This is also particularly preferred in order to provide in the respective operating mode the optimally adapted fuel storage volume for the first fuel in the first fuel storage subspace and the second fuel in the second fuel storage subspace.

Preferentially, the fuel storage space in a first portion has a first diameter and in a second portion a second diameter, wherein the second diameter is greater than the first diameter, wherein the first stop for the piston is formed at a first end of the second portion, and wherein the second stop for the piston is formed at a second end of the second portion, at which the second portion adjoins the first portion. Depending on the fuel pressures in the fuel storage subspaces, the piston is moved either automatically against the first stop or against the second stop in order to provide in the respective operating mode, the respective optimised storage volume for the respective fuel.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a cross-section in the longitudinal direction or axial direction through a fuel injector in a first state, in a first operating mode of the internal combustion engine;

FIG. 2: is a cross-section in the longitudinal direction or axial direction through a fuel injector in a second state, in a second operating mode of the internal combustion engine;

FIG. 3: is a fuel injector that can be provided in the first operating mode of the internal combustion engine; and

FIG. 4: is a fuel injection that can be provided in the second operating mode of the internal combustion engine.

### DETAILED DESCRIPTION OF THE PRESENTLY PREFERRED EMBODIMENTS

The disclosure relates to a fuel injector of an internal combustion engine. Such a fuel injector is designed for supplying fuel to a combustion chamber of a cylinder of the internal combustion engine.

The fuel injector according to one aspect of the invention serves for supplying different fuels to an internal combustion engine designed in particular as dual fuel internal combustion engine, namely in a first operating mode a first, relatively ignitable fuel and in a second operating mode a second, relatively less ignitable fuel and the first, relatively ignitable fuel, in order to ignite in the second operating mode the second, relatively less ignitable fuel with the help of the first, relatively ignitable fuel. In the second operating mode, the first, relatively ignitable fuel serves as pilot fuel. The first, relatively ignitable fuel is in particular a diesel fuel. The second, relatively less ignitable fuel can be methanol, ethanol or ammonia.

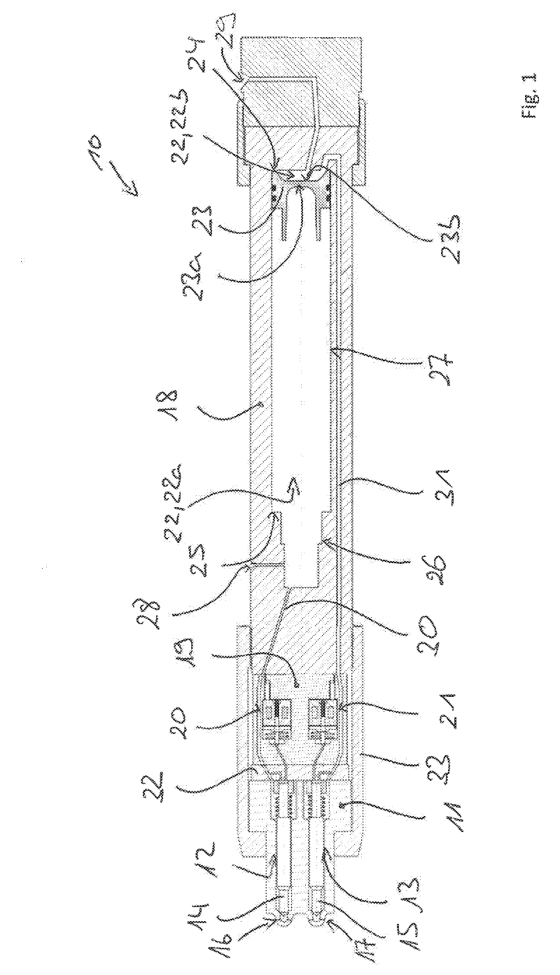

FIG. 1 shows a cross-section through a first fuel injector 10 according to one aspect of the invention, wherein the fuel injector 10 comprises a nozzle needle receiving body 11, which provides a first nozzle guide 12 for a first nozzle needle 14 and a second needle guide 13 for a second nozzle needle 15. Further, the nozzle needle receiving body 11 provides first fuel injection orifices 16 and second fuel injection orifices 17. Depending on the position of the nozzle needles 14, 15, the same open or block a fuel flow through the fuel injection orifices 16, 17.

Further, the fuel injector 10 according to one aspect of the invention comprises a fuel storage space receiving body 18 and in the shown exemplary embodiment a solenoid valve receiving body 19 arranged between the fuel storage space receiving body 18 and the nozzle needle receiving body 11.

A first solenoid valve 20 arranged in the solenoid valve receiving body 19 serves for controlling the first nozzle needle 14, in order to either open or block the fuel flow through the first fuel injection orifices 16 by changing the position of the first nozzle needle 14.

A second solenoid valve 21 arranged in the solenoid valve receiving body 19 serves for controlling the second nozzle needle 15, in order to change the position of the second nozzle needle 15 and depending thereon, either open or block the fuel flow of the second fuel through the second fuel injection orifices 17.

As already explained, the fuel injector 10 comprises the fuel storage space receiving body 18. In the fuel injector 10, namely in the fuel storage space receiving body 18 of the same, a fuel storage space 22 is integrated. In the fuel storage space 22, a piston 23 is moveably guided. Depending on its position in the fuel storage space, the piston 23 divides the fuel storage space 22 into a first fuel storage subspace 22a for the first fuel and a second fuel storage subspace 22b for the second fuel. The position of the piston 23 in the fuel storage space 22 is defined by stops. In the first operating mode of the internal combustion engine, the piston 23 according to FIG. 1 lies against a first stop 24. In the first operating mode of the internal combustion engine, exclusively the first fuel is combusted in the cylinders of the same, so that a volume of the first fuel storage subspace 22a is then maximal. Then, the volume of the first fuel storage subspace 22a takes up the total volume of the fuel storage space 22 or almost the total volume of the fuel storage space 22. In particular, when the volume of the first fuel storage subspace 22a takes up almost the total volume of the fuel storage space 22, the volume of the first fuel storage subspace 22a is more than 90%, preferentially more than 95%, particularly preferably more than 97% of the total volume of the fuel storage space 22.

In a second operating mode of the internal combustion engine, the piston 23 of the respective fuel injector 10 lies against a second stop 25. In particular, when the piston 23, in the second operating mode of the internal combustion engine, in which the same combusts the second fuel using the first fuel as pilot fuel, lies against the second stop 25, the first fuel storage subspace 22a takes up a first part volume of the total volume of the fuel storage space 22 and the second fuel storage subspace 22b a second part volume of the total volume of the fuel storage space 22, wherein the second part volume of the second fuel storage subspace 22b, in which the second fuel is stored, is greater than the first part volume of the first fuel storage subspace 22b, in which in the second operating mode the first fuel serving as pilot fuel is stored.

On a first side 23a, the piston 23 has a first effective piston area and on a second side 23b, a second effective piston area. These two piston areas are dimensioned in such a manner that in the first operating mode of the internal combustion engine, the piston 23, depending on the fuel pressures effective on its piston areas, lies against the first stop 24 and in the second operating mode, depending on the fuel pressures then effective on the piston areas of the two sides 23a, 23b, lies against the at least one second stop 25.

In the first operating mode, in which exclusively the first, relatively ignitable fuel is combusted, the fuel pressure present on the second side 23b of the piston 23 is so low that the piston 23, based on the fuel pressure present in the first fuel storage subspace 22a, is moved against the first stop 24. In particular, when in the second operating mode of the internal combustion engine, both the second, relatively less ignitable fuel and the first, relatively ignitable fuel are combusted, the piston, based on the fuel pressures then present in the fuel storage subspaces 22a, 22b of first fuel and second fuel, and depending on the effective piston areas of the piston 23, lies against the second stop 25.

The effective second piston area present in the region of the second side 23b of the piston 23 is greater than the effective piston area of the piston 23 present on the first side 23a of the piston 23, so that in particular, even when the fuel pressure in the first fuel storage subspace 22a is greater than the fuel pressure in the second fuel storage subspace 22b, the piston 23 is pressed against the second stop 25.

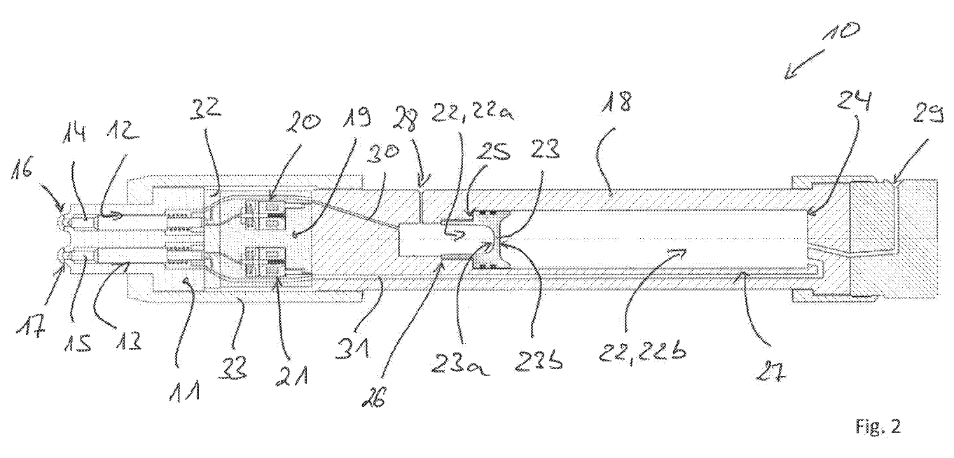

According to FIG. 1 and 2, the fuel storage space 22 in a first portion has a first diameter and in a second portion 27 a second diameter, wherein the second diameter is greater than the first diameter. The first stop 24 is formed on a first end of the second portion 27, the second stop 25 is formed on a second end of the second portion 27, on which the second portion 27 adjoins the first portion 26.

In particular, when the piston 23 of the fuel injector 10, in the second operating mode of the internal combustion engine, takes up the position shown in FIG. 2 and lies against the second stop 25, the diameter of the first fuel storage subspace 22a corresponds to the diameter of the first portion 26 and the diameter of the second fuel storage subspace 22b to the diameter of the second portion 27. In particular, when in the first operating mode of the internal combustion engine the piston 23 takes up the position shown in FIG. 1, the first fuel storage subspace 22a extends over both portions 26 and 27 of the fuel storage space 22.

Accordingly, the fuel storage space 22 of the fuel injector 10 represents a storage volume which, depending on the operating mode of the internal combustion engine and depending on the then effective fuel pressures of the piston 23 and depending on the position of the piston 23 then materialising, provides an adapted storage volume for the first fuel and the second fuel.

In the first operating mode, the first fuel pressure of the first fuel can be between 1200 bar and 2400 bar, the fuel pressure of the second fuel is not effective in the first operating mode. In the second operating mode, the fuel pressure of the first fuel can be between 1200 bar and 1800 bar and the fuel pressure of the second fuel between 400 bar and 1200 bar. The effective piston areas of the piston 23 on both its sides 23a, 23b located opposite one another are dimensioned in such a manner that depending on the respectively effective fuel pressure, the piston 23, in the second operating mode, takes up the position shown in FIG. 2 and in the first operating mode, the position shown in FIG. 1.

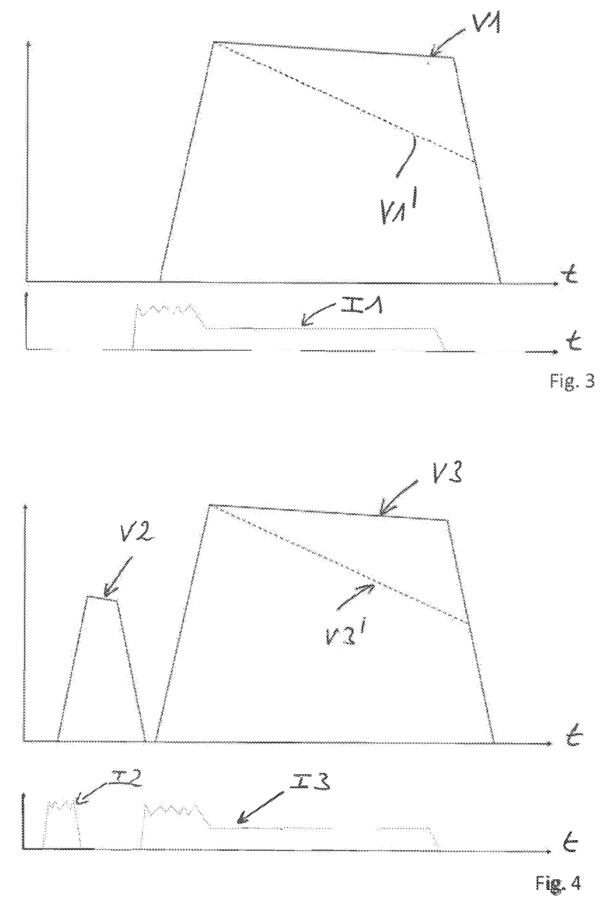

With the fuel injector 10 according to one aspect of the invention, the volumetric flow V1 shown in FIG. 3 can be provided for the first fuel in the first operating mode of the internal combustion engine, in which the same takes up the state of FIG. 1 upon energisation of the first solenoid valve 20 via the control current I1 shown in FIG. 3, wherein in FIG. 3 a volumetric flow V1’ is shown in dashed line, which would materialise when in contrast with the invention the entire volume of the fuel storage space 22 for storing the first fuel could not be utilised in the first operating mode, but merely a part volume.

In the second operating mode of the internal combustion engine, in which the fuel injector 10 takes up the state of FIG. 2, the volumetric flow V2 for the first fuel and the volumetric flow V3 for the second fuel can be provided depending on the energisation I2 of the first solenoid valve 20 shown in FIG. 4 and the likewise shown energisation I3 of the second solenoid valve 21, wherein the dashed lineation shows a volumetric flow V3’, which would form then, when in contrast with the invention merely a smaller storage volume for the second fuel would be available.

The first fuel storage subspace 22a is connected via a high-pressure connection 28 of the fuel injector 10 to a high-pressure circuit for the first fuel, whereas the at least one second fuel storage subspace 22b is connected via a further high-pressure connection 29 to a high-pressure circuit of the second fuel. In the first operating mode of the internal combustion engine, no fuel pressure is present at the high-pressure connection 29 of the high-pressure circuit of the second fuel.

The first fuel storage subspace 22a of the fuel injector 10 according to the invention, is connected via a first fuel line 30 and the at least one second fuel storage subspace 22b of the fuel injector 10 according to the invention via a second fuel line 31 to the nozzle needle receiving body 11, wherein these fuel lines 30, 31, emanating from the fuel storage space receiving body 18 extend via the solenoid valve receiving body 19 and preferentially a plate-like intermediate body 32 arranged between the solenoid valve receiving body 19 and the nozzle needle receiving body 11, in the direction of the nozzle needle receiving body 11.

FIG. 1, 2 further show a sleeve body 33, wherein the solenoid valve receiving body 19 and the intermediate body 28 are each arranged completely and the nozzle needle receiving body 11 and the fuel storage space receiving body 18 each partly within the sleeve body 33. The sleeve body 33 is screwed to the fuel storage space receiving body 18. By way of the sleeve body 33, the fuel injector 10 can be mounted, for example, in a corresponding recess in a cylinder head of a cylinder of the internal combustion engine.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A fuel injector of an internal combustion engine, configured to supply fuel to a combustion chamber of a cylinder of the internal combustion engine, comprising:
a first nozzle needle moveably guided in a first needle guide, which interacts with first fuel injection orifices such that depending on a first nozzle needle position, either opens or blocks a fuel flow of a first fuel through the first fuel injection orifices;
a second nozzle needle moveably guided in a second needle guide, which interacts with second fuel injection orifices such that depending on a second nozzle needle position, either opens or blocks a fuel flow of a second fuel through the second fuel injection orifices;
a fuel storage space; and
a piston moveably guided in the fuel storage space, wherein the piston divides the fuel storage space depending on its position in the fuel storage space, into a first fuel storage subspace for the first fuel and into a second fuel storage subspace for the second fuel.

2. The fuel injector according to claim 1, further comprising:
a first stop for the piston, against which the piston lies in a first operating mode of the internal combustion engine; and
a second stop for the piston, against which the piston lies in a second operating mode of the internal combustion engine.

3. The fuel injector according to claim 2,
wherein when the piston lies against the first stop, in the first operating mode of the internal combustion engine, in which the internal combustion engine exclusively combusts the first fuel, a volume of the first fuel storage subspace is maximal such that the volume of the first fuel storage subspace takes up a total volume of the fuel storage space or almost the total volume of the fuel storage space.

4. The fuel injector according to claim 2,
wherein when the piston, lies against the second stop, in the second operating mode of the internal combustion engine, in which the internal combustion engine combusts the second fuel utilising the first fuel as pilot fuel, the first fuel storage subspace takes up a first part volume of a total volume of the fuel storage space and the second fuel storage subspace a second part volume of the total volume of the fuel storage space, wherein the first part volume is greater than the first part volume.

5. The fuel injector according to claim 2,
wherein the piston comprises on a first side an effective first piston area and on a second side an effective second piston area which are dimensioned in such a manner that in the first operating mode of the internal combustion engine the piston, depending on fuel pressures effective on its piston areas, lies against the first stop and in the second operating mode of the internal combustion engine, the piston, depending on fuel pressures effective on its piston areas, lies against the second stop.

6. The fuel injector according to claim 5,
wherein when in the second operating mode of the internal combustion engine the piston lies against the second stop, when the fuel pressure of the first fuel then effective in a region of the first fuel storage subspace lies against the first piston area and the fuel pressure of the second fuel lies against the second piston area then effective in the region of the second fuel storage subspace, wherein the effective second piston area is greater than the effective first piston area.

7. The fuel injector according to claim 2, wherein:
the fuel storage space in a first portion has a first diameter and in a second portion has a second diameter, wherein the second diameter is greater than the first diameter,
the first stop for the piston is formed at a first end of the second portion,
the second stop for the piston is formed at a second end of the second portion, at which the second portion adjoins the first portion.

8. The fuel injector according to claim 3,
wherein when the piston, lies against the second stop, in the second operating mode of the internal combustion engine, in which the internal combustion engine combusts the second fuel utilising the first fuel as pilot fuel, the first fuel storage subspace takes up a first part volume of the total volume of the fuel storage space and the second fuel storage subspace a second part volume of the total volume of the fuel storage space, wherein the first part volume is greater than the first part volume.

9. An internal combustion engine, comprising:
cylinders; and
a fuel injector for each cylinder comprising:
a first nozzle needle moveably guided in a first needle guide, which interacts with first fuel injection orifices such that depending on a first nozzle needle position, either opens or blocks a fuel flow of a first fuel through the first fuel injection orifices;
a second nozzle needle moveably guided in a second needle guide, which interacts with second fuel injection orifices such that depending on a second nozzle needle position, either opens or blocks a fuel flow of a second fuel through the second fuel injection orifices;
a fuel storage space; and
a piston moveably guided in the fuel storage space, wherein the piston divides the fuel storage space depending on its position in the fuel storage space, into a first fuel storage subspace for the first fuel and into a second fuel storage subspace for the second fuel.
